(19) United States
(12) Patent Application Publication
(10) Pub. No.: US 2018/0133522 A1
(43) Pub. Date: May 17, 2018

(54) Drawing-in/out Device for Rescue Wire for Waist Belt

(71) Applicant: Hee Chang PARK, Seoul (KR)

(72) Inventor: Hee Chang PARK, Seoul (KR)

(21) Appl. No.: 15/802,995

(22) Filed: Nov. 3, 2017

(30) Foreign Application Priority Data
Nov. 16, 2016 (KR) 20-2016-0006657
Sep. 7, 2017 (KR) 20-2017-0004742

(51) Int. Cl. A62B 1/10; B63C 9/13; A62B 1/16

(52) U.S. Cl. CPC A62B 1/10; A62B 1/16; B63C 9/13

(57) ABSTRACT

Disclosed herein is a drawing-in/out device for a rescue wire for a waist belt, wherein a reel on which a wire has been wound is disposed within a connection tool to which the buckle of a belt worn on the waist is fixed so that a rescue function can be performed in order to prevent the tangling or twisting of the wire in a process of drawing out a rescue rope or winding the rescue rope after use for the purpose of a rescue in an emergency situation, the reel is disposed in a compact structure in order to improve an external appearance and marketability of the belt, and the connection tools can be consecutively connected to secure the wire of a length sufficient for lifesaving in order to maintain safety, if necessary.

### TECHNICAL FIELD

The present invention relates to a drawing-in/out device for a rescue wire for a waist belt and, more particularly, to a drawing-in/out device for a rescue wire for a waist belt, wherein a reel on which a wire has been wound is disposed within a connection tool to which the buckle of a belt worn on the waist is fixed so that a rescue function can be performed in order to prevent the tangling or twisting of the wire in a process of drawing out a rescue rope or winding the rescue rope after use for the purpose of a rescue in an emergency situation, the reel is disposed in a compact structure in order to improve an external appearance and marketability of the belt, and the connection tools can be consecutively connected to secure the wire of a length sufficient for lifesaving in order to maintain safety, if necessary.

### BACKGROUND ART

In general, when a human life is a dangerous state while swimming in the water, a life belt having a rope is used as means for rescuing a person. In an emergency situation in which the rescue device is not present, a corresponding person may be out of danger using all of available rescue means, such as a rope, a pole and a buoyancy body which may be obtained on the spot. A belt worn on the waist may be used as one of such rescue means.

If the belt is used as the rescue means, it is difficult to handle a dangerous situation occurring in a long distance because the length of a strap is limited to a length proportional to the circumference of the waist. Furthermore, there is a problem in that the safety of rescuer is in danger even in a short distance.

As a conventional technology for solving the problems of a belt used as rescue means, there has been proposed Korean Patent No. 10-0555632 used for lifesaving, uniting and binding, wherein the space of a pocket form is formed within a band member forming a belt, a rope having proper tension is received in the space, and when an emergency situation occurs, the rope, together with a buckle, is drawn out from the band member to extend the length of the band member.

However, the prior patent has problems in that a task for accumulating and receiving the rope within the space formed in the band member is inconvenient, an elastic property and a feeling of wearing are poor due to an excessive thickness of the band member, and availability is low because a task for receiving an drawn rope within the band member again after the rope is drawn out from the band member is almost impossible.

In accordance with a buckle for rescue disclosed in “Korean Utility Model No. 1993-0006093”, that is, another example of a conventional technology, a casing in which a reel capable of winding a thin rope made of strong synthetic resin has been embedded is assembled in front of the buckle provided in a belt. When saving a life, the rope is drawn out from the casing. After rescue, the rope is wound on the reel of the casing.

The lifesaving buckle having such a reel structure has an advantage in that it can be reused because the rope is unwound from the casing and then wound in the original state again, but has problems in that weight is heavy and a wearer feels a lot of inconvenience when wearing the belt because the casing is assembled to be protruded outside the buckle and the size of the buckle is increased in a process of installing parts, such as the reel capable of winding the rope, a handle and a fixture. Furthermore, the lifesaving buckle has a problem in that it is almost impossible to dispose the casing in front of the buckle because if the length of the rope is lengthily extended, the sizes of the reel and the casing in which the reel is disposed are inevitably increased in proportion to the extended length.

Furthermore, from the nature of a belt product, from the point of view that an external appearance and design of an externally exposed buckle attracts a consumer's purchasing need, a belt whose casing has been protruded outside a buckle has a problem in that it has very low marketability because the belt has an unshaped form and size, and also has a problem in that a user may not want to wear the belt because an external beauty is poor if the buckle whose size and weight are great is externally exposed when the user wears the belt.

In particular, in the conventional technologies, when the rope is drawn out from the reel on which the rope (hereinafter referred to as a “wire”) made of synthetic resin has been wound, if the rotating speed of the reel is faster than the drawing-out speed of the wire because acceleration is applied to the reel, the wire wound on the reel is excessively unwound before the wire is drawn out. As a result, the excessively unwound wire and an already drawn-out wire are tangled, that is, a so-called backlash phenomenon is generated. When the wire is rewound on the reel after use, the wire loosely contacts the reel and is wound on the reel, thereby being twisted, or the wire is detached from the reel and wound on the reel. Accordingly, there is a problem in that the drawing out or winding of the wire is impossible.

### DISCLOSURE

### Technical Problem

The present invention has been made keeping in mind the problems of the conventional buckle having a rescue function, and an object of the present invention is to provide a drawing-in/out device for a rescue wire for a waist belt, which can prevent the deterioration of an external appearance by disposing a wire capable of lifesaving in a connection tool concealed by a strap when a belt is worn in such a manner that the wire is unwound and wound and can secure a wire of a sufficient length by enabling the one or more connection tools to be consecutively connected.

Another object of the present invention is to provide a drawing-in/out device for a rescue wire for a waist belt, which enables a wire for lifesaving to be smoothly drawn out or wound by preventing a phenomenon in which the wire is tangled or twisted when the wire is drawn out or rewound because a reel on which the wire has been wound is disposed within a connection tool to which the buckle of a belt has been fastened.

### Technical Solution

In an embodiment of the present invention, a drawing-in/out device for a rescue wire for a waist belt includes a guide member closely attached to a wire wound on a reel with applying an elastic force to the wire from the outside of the wire on the upper and lower sides to the inside and disposed to control the drawing and winding operation of the wire when the reel on which the wire having a length and tension capable of lifesaving has been wound is disposed within a connection tool coupling a support provided in a buckle and a fixture to which a strap formed of a strip of leather or fabrics has been inserted and fixed in such a way as to be rotated by a shaft, a handle part equipped with a handle and disposed in a portion externally protruded from the shaft in such a way as to be folded or unfolded based on a hinge, a latching part disposed to draw the wire wound on the reel out to the outside through a through hole formed on the side of the connection tool and then to fix the end part of the wire, latching protrusions disposed to be detached from latching holes at the top and bottom of the connection tool when a force to contract the elastic force of a spring is applied to at least one of both sides of the latching part inserted and fixed to the latching holes, respectively, and a safety plate formed on the other side of the connection tool in such a way as to be caught in the support provided in the buckle, having a hook equipped with a cut groove formed therein, and provided at the entrance of the hook to maintain a closed state by the tension of a spring so that the support received in the safety plate is not detached.

In another embodiment of the present invention, in a waist belt in which the support of a buckle is constrained by a hook formed on one side of a connection tool, latching holes are formed on the other side of the connection tool corresponding to the buckle, a latching part equipped with elastic protrusions is coupled to be inserted or detached from the latching holes, and a strap is settled in the state in which the front end of a wire has been fixed to the latching part, a depressed space sealed by a cover is formed so that a reel having a wire wound thereon is received in the back surface of the connection tool, a shaft hole penetrating the front and back of the connection tool is formed in the middle of the depressed space so that a short shaft provided on both sides of the reel are rotatably coupled, a hole through which the reel is rotated by a dedicated tool and a long groove rotated by a simple tool, such as a coin or driver, are formed in parallel on the center line of the short shaft, and a guide member is disposed on one side of the depressed space and closely attached to the wire wound on the reel with applying an elastic force from the outside of the wire on the upper and lower sides to the inside, and controls the drawing and winding operation of the wire.

### Advantageous Effects

As described above, the buckle and the strap worn on the waist are configured to be coupled by the one or more connection tools that enable the wire to be drawn or wound. Accordingly, the present invention has an effect in that it can improve an external appearance and marketability according to the wearing of the belt because the end part of the strap settled in the connection tool through the inside of the buckle when the belt is worn conceals the one or more connection tools.

Furthermore, the present invention has an advantage in that the wire can be smoothly drawn out or wound because a tangling phenomenon which may occur when the wire is drawn out and a twisting phenomenon which may occur when the wire is rewound are prevented by the guide member closely attached to the outside of the wire on the upper and lower sides by its elasticity of the sheet spring when the wire is drawn out.

Furthermore, if the one or more connection tools are continuously connected between the buckle and the strap, an emergency situation can be handled by securing the wire of a sufficient length in proportion to the connection tools. Accordingly, the present invention has an advantage in that the wire can be used for various rescue task and safety purposes in the safe state.

Furthermore, the present invention has advantages in that it can prevent a phenomenon in which the wire is tangled by controlling the drawing-out speed of the wire and the rotation of the reel by the elastic force of the guide member closely attached to the outside of the wire on the upper and lower sides when the wire is drawn out from the reel disposed in the connection tool, and the wire can be smoothly drawn out or rewound by preventing a phenomenon in which the wire is tangled or detached from a bobbin when the drawn wire is rewound.

### DESCRIPTION OF DRAWINGS

FIG. 1 is a perspective view showing a partial and exploded part of a drawing-in/out device for a rescue wire for a waist belt according to an embodiment of the present invention.

FIGS. 2a and 2b are a plan view showing the state in which the drawing-in/out device for a rescue wire for a waist belt has been coupled and a front view thereof.

FIG. 3 is a front view showing the state in which a wire has been drawn out from FIG. 2b.

FIGS. 4a and 4b are a plan view of a modified example of the drawing-in/out device for a rescue wire for a waist belt and a front view thereof.

FIG. 5 is a front view showing the state in which the wire has been drawn out from the modified example of FIG. 4b.

FIG. 6 is an exploded perspective view of a drawing-in/out device for a rescue wire for a waist belt according to another embodiment of the present invention.

FIGS. 7a and 7b are a front view showing that part of FIG. 6 has been enlarged and a front view showing the state in which a wire for lifesaving has been drawn out.

<Description of reference numerals>

| | |
|---|---|
| 10: buckle | 11: support |
| 20: fixture | 21: clamp |
| 22, 35: hook | 23, 35′: cut groove |
| 24, 36: safety plate | 30: connection tool |
| 31: cover | 32: handle part |
| 32′: handle | 33: shaft |
| 33′: hinge | 34: latching part |
| 34′: elastic protrusion | 37: through hole |
| 38: latching hole | 39: depressed space |
| 39′: protruded jaw | 39a: shaft hole |
| 40: guide member | R: reel |
| R1: short shaft | R2: hole |
| R3: long groove | S: strap |
| W: wire | |

### MODE FOR INVENTION

Hereinafter, a drawing-in/out device for a rescue wire for a waist belt according to embodiments of the present invention is described in detail with reference to the accompanying drawings.

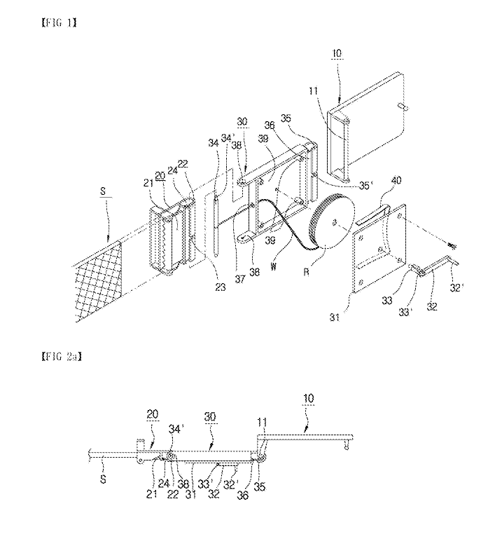

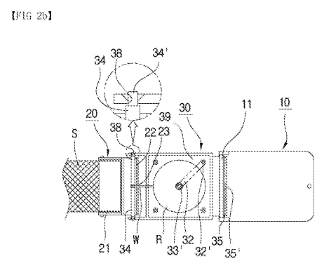

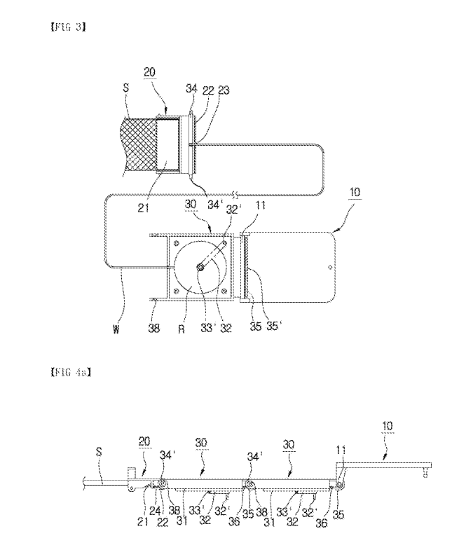

FIG. 1 is a perspective view showing a partial and exploded part of a drawing-in/out device for a rescue wire for a waist belt according to an embodiment of the present invention. FIGS. 2a and 2b are a plan view showing the state in which the drawing-in/out device for a rescue wire for a waist belt has been coupled and a front view thereof. In the present invention, when a fixture 20 including a clamp 21 is connected to a support 11 provided in a buckle 10 and a strap S formed of a strip of leather or fabrics so that the fixture and the strap are inserted and fixed to the fixture, the support, the fixture and the strap are coupled through the medium of a connection tool 30 on which a wire W capable of lifesaving is mounted to be drawn out or rewound.

A hook 22 having a cut groove 23 is formed in the middle of the fixture 20 to which the strap S is inserted and fixed so that the hook is caught in the latching part 34 of the connection tool 30 neighboring the fixture. A safety plate 24 for maintaining a closed state by the tension of a spring is provided at the entrance of the hook 22 so that the latching part 34 received within the hook is not randomly detached from the hook.

A depressed space 39 is formed within the connection tool 30. After a reel R on which the wire W having a length and tension capable of lifesaving has been wound is disposed in the depressed space 39, the reel and the depressed space are coupled and shielded by a cover 31. In this case, a shaft 33 supporting the reel R so that the reel is rotatable is formed through the reel. A handle part 32 having a handle 32′ in such a way as to be folded or unfolded based on a hinge 33′ is coupled to a portion of the shaft 33 externally protruded from the shaft.

The handle 32′ formed at the end of the handle part 32 is folded to the other side based on the hinge 33′ when the drawing or winding operation of the wire W is completed. Accordingly, as shown in FIG. 2b, the handle 32′ is inserted into any one groove formed at the edge of the cover 31, thereby functioning as a stopper for stopping the rotation of the shaft 33 while preventing the exposure of the handle.

The end of the wire W drawn out from the reel R is fixed to the middle of the latching part 34 disposed adjacent to a through hole 37 formed on the side of the connection tool 30 via the through hole 37. The latching part 34 includes latching protrusions 34′ to at least one side of which an elastic force of the spring is applied. When the latching part 34 presses the latching protrusions 34′ in the state in which they have been inserted and fixed to the upper and lower latching holes 38 of the connection tool 30, the latching part 34 is detached from the latching holes 38, so the wire W wound on the reel R is drawn out.

In this case, each of the outsides of the latching holes 38 formed at the top and bottom of the connection tool 30 may be processed in the form of a wedge groove so that they can easily press the latching protrusions 34′ inserted thereto, as in the partial enlarged view of FIG. 2b.

A hook 35 having a cut groove 35′ formed in a middle thereof so that the support 11 provided in the buckle 10 is caught in the hook is formed on the other side of the connection tool 30. A safety plate 36 for maintaining the closed state by the tension of a spring so that the support 11 received in the hook is not randomly detached is provided at the entrance of the hook 35.

When the latching part 34 is caught in the cut grooves 23 and 35′ formed in the hook 22 provided in the fixture 20 and the hook 35 provided in the connection tool 30, respectively, the cut grooves 23 and 35′ are used as the passages of the wire W fixed to the central part of the latching part, thereby facilitating a connection task. The safety plates 24 and 36 provided at the entrances of the respective hooks 22 and 35 are open when the latching part 34 and the support 11 to be caught enter the safety plates 24 and 36 or apply a force so that the elastic force of the spring is artificially offset, and then maintain the closed state when the elastic force of the spring acts on them. Accordingly, the latching part 34 and the support 11 confined in the hooks 23 and 35 are not randomly separated.

A guide member 40 is disposed on one side of the depressed space 39 and closely attached to the wire with applying an elastic force of a sheet spring form to the wire from the outside of the wire W wound on the reel R on the upper and lower sides to the inside, and controls the drawing and winding operation of the wire. When the cover 31 is fixed using bolts, the guide member 40 may be supported by a plurality of protruded jaws 39′ formed in the depressed space 39 so that the bolts are screwed onto the cover in order to prevent the guide member from hindering the drawing or winding operation.

That is, the guide member 40 is closely attached to the outside of the wire W wound on the reel R on the upper and lower sides by the elasticity of the sheet spring. Accordingly, a so-called backlash phenomenon in which the wire is tangled when the rotation of the reel R becomes faster than the drawing-out speed of the wire W while the wire W is drawn out can be prevented, and a twisting phenomenon generated when the wire is rewound can be prevented.

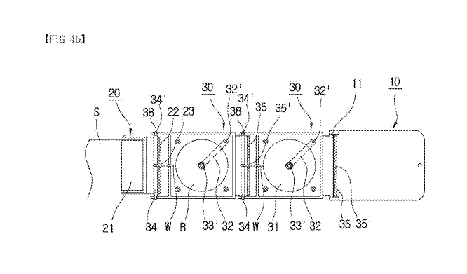

FIG. 3 is a front view showing the state in which the wire has been drawn out. When an emergency situation is generated in the state in which a user has worn a belt equipped with the drawing-in/out device for a rescue wire according to the present invention, the user releases the constrained state of the handle 32′ of the handle part 32 closely attached to the cover 31 on the back side of the connection tool 30 by releasing the belt so the shaft 33 of the reel R on which the wire W has been wound is rotatable. Next, the user presses the latching protrusions 34′ of the latching part 34 coupled to the latching holes 38 at the top and bottom of the connection tool 30, so the latching part 34 is detached from the latching holes 38. Accordingly, the wire W wound on the reel R, together with the fixture 20 to which the strap S has been fixed, is drawn out to a required length and used for rescue.

When the rescue is terminated in the state in which the wire W has been drawn out from the reel R disposed in the connection tool 30, the shaft 33 is rotated in the winding direction using the handle 32′ of the handle part 32 so that the drawn wire W is rewound on the reel R. When the handle part 32 is folded in the opposite direction based on the hinge 33′ in the state in which the winding operation has been completed, the handle 32′ provided at the end of the handle part 32 is inserted into any one of the holes formed in the cover 31 and constrained thereby. Accordingly, the drawing of the wire W is stopped and the wire is used for a next opportunity.

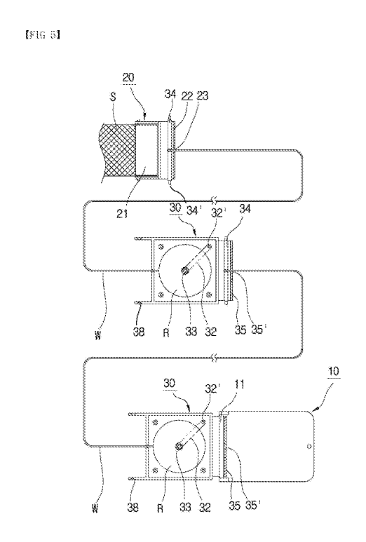

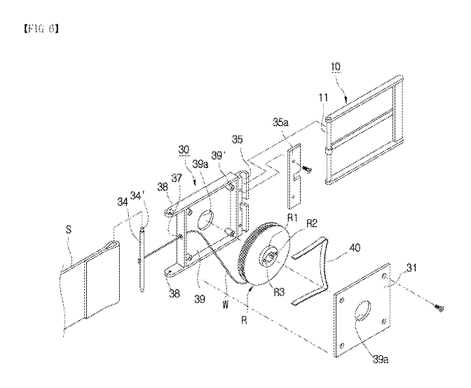

FIGS. 4a and 4b are a plan view of a modified example of the drawing-in/out device for a rescue wire for a waist belt and a front view thereof. FIG. 5 is a front view showing the state in which the wire has been drawn out from the modified example of FIG. 4b. In the previous embodiment, the belt in which the support 11 provided in the buckle 10 and the fixture having the strap S inserted and fixed thereto have been connected through the medium of the one connection tool 30 has been described. In contrast, the present embodiment illustrates a belt in which another connection tool is continuously connected between the support 11 of the buckle 10 and the connection tool 30 connected in the previous embodiment or between the fixture 20 to which the strap S has been inserted and fixed and the connection tool 30 connected in the previous embodiment in the state in which two or more connection tools 30 have been prepared. Accordingly, a case where rescue is insufficient using the wire W provided in one connection tool 30 can be handled because the wire W of a sufficient length is secured.

That is, the belt is configured by continuously connecting the plurality of connection tools 30 in the process of interconnecting the support 11 provided in the buckle 10, the hook 35 and the latching part 34 respectively provided on both sides of the connection tool 30, and the hook 22 of the fixture 20 to which the strap S has been fixed. Accordingly, when the configured belt is worn, the end part of the strap S settled through the inside of the buckle 10 and fixed to the buckle 10 maintains the state in which the front of the one or more connection tools 30 and the fixture 20 are covered. As a result, an external appearance and marketability according to the wearing of the belt can be improved because elements, such as the connection tool 30 and the fixture 20 of the strap, other than the buckle 10 are concealed.

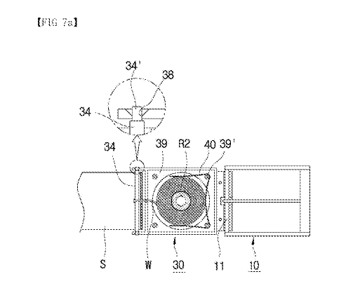

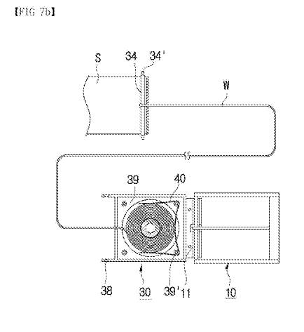

FIG. 6 is an exploded perspective view of a drawing-in/out device for a rescue wire for a waist belt according to another embodiment of the present invention. FIGS. 7a and 7b are a front view showing that part of FIG. 6 has been enlarged and a front view showing the state in which a wire for lifesaving has been drawn out. The present embodiment relates to an embodiment in which the decoration of a buckle 10 has a hanger loop form, a reel R having a wire W wound thereon is disposed within a connection tool 30, and a strap S has been settled.

A hook 35 has been formed on one side of the connection tool 30, and a support 11 provided the buckle 10 has been inserted into the hook. In this state, the support 11 is constrained by a fixing plate 35a coupled by bolts. Latching holes 38 are formed over and under the buckle 10 on the other side of the buckle 10. A latching part 34 having an elastic protrusion 34′ is coupled to the latching holes 38 in such a way as to be inserted or detached. The strap S is settled in the latching part 34 in the state in which the front end of the wire W has been fixed to the strap.

In order to mount the reel R having the wire W wound thereon on a depressed space 39 formed by a cover 31 coupled to the back side of the connection tool 30, a shaft hole 39a is formed to penetrate the front and back of the depressed space 39, a short shaft R1 provided on both sides of the reel R is rotatably coupled to the shaft hole, and the wire W wound on the reel R is drawn out to the outside of the depressed space 39 through a through hole 37 formed in the middle of the connection tool 30 on one side thereof. Accordingly, when rotary power is applied to the reel R by a force applied when the wire W is drawn, the short shaft R1 provided on both sides of the reel is supported by the shaft hole 39a penetrating the depressed space 39 and rotated.

A hole R2 through which the reel R is rotated by a dedicated tool and a long groove R3 rotated using a simple tool, such as a coin or driver, are formed in parallel on the center line of the short shaft R1. A guide member 40 is disposed on one side of the depressed space 39. The guide member is closely attached in the state in which it has applied an elastic force of a sheet spring form from the outside of the wire W wound on the reel R on the upper and lower sides thereof to the inside, thus controlling the drawing and winding operation of the wire.

Accordingly, in the reel R rotatably supported by the shaft hole 39a within the depressed space 39 provided in the connection tool 30, means for rewinding the drawn wire can be rewound by an externally coupled tool using the hole R2 or long groove R3 of the short shaft R1 exposed to the outside of the buckle. Accordingly, the buckle can be fabricated simply and compactly compared to a conventional technology.

Accordingly, after the elastic protrusion 34′ is detached from the latching holes 38 at the top and bottom of the connection tool 30 on one side thereof, when the strap S settled in the latching part 34 is separated from the elastic protrusion, the wire W having the front end fixed to the latching part 34 is drawn out from the reel R disposed in the depressed space 39 of the connection tool 30. Accordingly, the wire can be used for lifesaving or in an emergency situation.

In the above embodiments, the front end of the wire W has been illustrated as being fixed to the latching part 34. For example, the front end of the wire W drawn out to the outside of the depressed space 39 through the through hole 37 may form a knot in such a way as to be not returned to the through hole 37, and may be drawn separately from the latching part 34.

1. A drawing-in/out device for a rescue wire for a waist belt comprising a fixture (20) equipped with a clamp (21) so that a support (11) provided in a buckle (10) and a strap (S) formed of a strip of leather or fabrics are inserted and fixed to the fixture, wherein:
a hook (22) having a cut groove (23) and a safety plate (24) maintaining a closed state by tension of a spring at an entrance of the hook are provided in the fixture (20) to which the strap (S) is fixed,
after a reel (R) on which a wire (W) having a length and tension capable of lifesaving has been wound is disposed within a connection tool (30) enabling a connection between the buckle (10) and the fixture (20), a cover (31) is coupled to the connection tool (30) to seal the connection tool (30), wherein a shaft (33) rotatably supporting the reel (R) is disposed in the connection tool (30) and a handle part (32) having a handle (32′) in such a way as to be folded and unfolded based on a hinge (33′) is disposed in a portion externally protruded from the shaft (33),
a front end of the wire (W) drawn out from the reel (R) is fixed to a middle of a latching part (34) disposed close to a through hole (37) through the through hole (37) formed on one side of the connection tool (30), wherein a latching protrusion (34′) to which an elastic force of a spring is applied is provided on at least one side of the latching part (34) and detached from latching holes (38) at a top and bottom of the connection tool (30) when the latching protrusion (34′) is pressed in the state in which the latching part (34) has been inserted and fixed to the latching holes (38), and
a hook (35) having a cut groove (35′) in a middle of the connection tool (30) in such a way as to be caught in the support (11) provided in the buckle (10) is formed on the other side of the connection tool (30), and a safety plate (36) maintaining the closed state by tension of a spring so that the hook is not detached from the support (11) received in the hook (35) is provided at an entrance of the hook 35.

2. The drawing-in/out device of claim 1, wherein:
a guide member (40) is disposed on one side of the depressed space (39) and closely attached to the wire with applying an elastic force of a sheet spring form to the wire from the outside of the wire W wound on the reel (R) on upper and lower sides to an inside, and controls a drawing and winding operation of the wire, and
when the cover (31) is fixed using bolts, the guide member (40) is supported by a plurality of protruded jaws (39)′ formed in the depressed space (39) so that the bolts are screwed onto the cover.

3. The drawing-in/out device of claim 1, wherein outsides of the latching holes (38) formed at the top and bottom of the connection tool (30) are processed in a wedge groove form so that the latching protrusion (34′) of the latching part (34) inserted into the latching holes (38) is easily pressed.

4. The drawing-in/out device of claim 1, wherein:
a plurality of the connection holes (30) is continuously connected between the support (11) provided in the buckle (10) and the fixture (21) to which the strap (20) has been fixed, and
when the belt is worn, an end part of the strap (20) settled in the buckle (10) through the inside of the buckle (10) is configured to conceal a front of the one or more connection tools (30) and the fixture (21).

5. A drawing-in/out device for a rescue wire for a waist belt, wherein:
a hook (35) is formed on one side of a connection tool (30) connecting a buckle (10) of a belt worn on a waist (10) and a strap (S), and a support (11) provided in the buckle (10) is inserted into the hook and constrained by a fixing plate (35a) fastened by bolts,
latching holes (38) are formed at a top and bottom of the buckle (10) on the other side, and a latching part (34) having an elastic protrusion (34′) is coupled to the latching holes in such a way as to be inserted and detached,
a front end of a wire (W) is fixed to the latching part (34) and the strap (S) is settled,
a shaft hole (39a) is formed to penetrate a front and back of the depressed space (39) formed by coupling a cover (31) to a back of the connection tool (30), and rotatably couples a short shaft (R1) provided on both sides of a reel (R) having the wire (W) wound thereon,
the wire (W) wound on the reel (R) is disposed to be drawn out to the outside of the depressed space (39) through a through hole (37) formed in the middle of the connection tool (30) on one side,
a hole (R2) through which the reel (R) is rotated by a dedicated tool and a long groove (R3) rotated by a tool, such as a coin or driver, are formed in parallel on a center line of the short shaft (R1), and
a guide member (40) is disposed on one side of the depressed space (39) and closely attached to the wire (W) wound on the reel (R) with applying an elastic force of a sheet spring form from an outside of the wire (W) on upper and lower sides to the inside, and controls a drawing and winding operation of the wire.
